(19) United States
(12) Patent Application Publication
(10) Pub. No.: US 2007/0136284 A1
(43) Pub. Date: Jun. 14, 2007

(54) Method for constructing and repurposing rhetorical content

(75) Inventors: John Neil Cobb, Plano, TX (US); Yeow Loong Lee, Saint Louis, MO (US); Michael J. Millard, Round Rock, TX (US); Lee Alan Cobb, Dallas, TX (US); Kristen Jane Sebastian, Dallas, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/299,507

(22) Filed: Dec. 12, 2005

(51) Int. Cl. G06F 7/00

(52) U.S. Cl. 707/7

(57) ABSTRACT

A system and method are disclosed for constructing and repurposing rhetorical content. A system that incorporates teachings of the present disclosure may include, for example, a content management system (400) having a database (404), and a controller (402) for managing the database. The controller can be programmed to construct (606) one or more rhetorical and structural elements from a rhetorical library and rhetorical content associated with the rhetorical library by functional attributes, and generate (610) a schematic expression from a combination of the one or more rhetorical and structural elements. Additional embodiments are disclosed.

### RELATED APPLICATIONS

U.S. Patent Application, Publication No. US2005/0033750, filed Aug. 6, 2003, by Cobb et al., entitled “RHETORICAL CONTENT MANAGEMENT SYSTEM AND METHODS”, whose contents are hereby incorporated by reference herein.

U.S. Patent Application, Publication No. US2005/0033754, filed Mar. 22, 2004, by Cobb et al., entitled “RHETORICAL CONTENT MANAGEMENT WITH TONE AND AUDIENCE PROFILES”, whose contents are hereby incorporated by reference herein.

U.S. patent application Ser. No. 11/230,015, Attorney docket no. 1033-EB1001, filed Sep. 19, 2005, by Allan et al., entitled “DATABASE STRUCTURE AND METHOD”, whose contents are hereby incorporated by reference herein.

U.S. patent application, Attorney docket no. 7785-90 (KV2209), filed Dec. 12, 2005, by Rege et al., entitled “METHOD FOR DECONSTRUCTING AND REPURPOSING RHETORICAL CONTENT”, whose contents are hereby incorporated by reference herein.

### FIELD OF THE DISCLOSURE

The present disclosure relates generally to content management systems, and more specifically to a method for constructing and repurposing rhetorical content.

### BACKGROUND

Documents and displayable media such as advertising materials contain “content.” Different content has different purposes, different formats, and different subject matter. Content that has meaning and purpose is typically referred to as rhetorical content.

Most businesses strive to provide a consistent image for all media materials. Content management may be useful, for example, in providing a consistent product description in advertising materials across multiple sales and marketing mediums such as websites, proposals, brochures, and other documents.

Managing content can be a significant challenge for businesses, creating significant costs for large multi-department organizations. Content reuse issues are made more difficult by variances in regional product availability, audience type, and target marketing. Thus, reoccurring creation and delivery of high quality content to customers and clients is often inefficient and expensive.

As such, expenses increase as content is manually adapted or edited for various uses and formats. It can be difficult for business and organizations to efficiently create content that is consistent, accurate, and readily available for reuse.

### BRIEF DESCRIPTION OF THE DRAWINGS

FIG. 1 depicts an exemplary embodiment of a rhetorical library with unpopulated variables of rhetorical topics;

FIG. 2 depicts an exemplary embodiment for populating variables in the rhetorical library;

FIG. 3 depicts an exemplary supplemental embodiment of rhetorical topics;

FIG. 4 depicts an exemplary embodiment of a content management system (CMS) for constructing and repurposing rhetorical content;

FIG. 5 depicts an exemplary embodiment of the CMS operating in a communication system;

FIG. 6 depicts an exemplary method operating in the CMS for constructing and repurposing rhetorical content; and

FIG. 7 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method for constructing and repurposing rhetorical content.

In a first embodiment of the present disclosure, a computer-readable storage medium operates in a content management system (CMS). The storage medium of the CMS has computer instructions for receiving a rhetorical purpose for generating a desired schematic expression. According to the rhetorical purpose, the storage medium of the CMS has computer instructions for constructing one or more rhetorical topics from a rhetorical library and rhetorical content associated with the rhetorical library according to one or more functional attributes, generating one or more communication units from a combination of the one or more rhetorical topics, and generating the desired schematic expression from a combination of the one or more communication units.

In a second embodiment of the present disclosure, a CMS has a controller for managing a database. The controller is programmed to construct one or more rhetorical and structural elements from a rhetorical library and rhetorical content associated with the rhetorical library by functional attributes, and generate a schematic expression from a combination of the one or more rhetorical and structural elements.

In a third embodiment of the present disclosure, a CMS has a controller for managing a database. The controller is programmed to construct in a first language one or more rhetorical and structural elements from a rhetorical library and rhetorical content associated to the rhetorical library by functional attributes, translate the one or more rhetorical and structural elements in the first language to one or more rhetorical and structural elements in a second language, and store the one or more rhetorical a elements in the second language with functional attributes that associate to a corresponding rhetorical library in the second language.

In a fourth embodiment of the present disclosure, a computing device has a controller programmed to receive a schematic expression from a content management system (CMS), wherein the schematic expression is generated by the CMS according to one or more communication units each having at least one or more rhetorical and structural elements, present portions of the schematic expression to one or more end users according to operating rules of the computing device, submit operating information to the CMS according to one or more operating metrics monitored by the CMS, and receive an updated portion of the schematic expression from the CMS in response to the operating information submitted to the CMS.

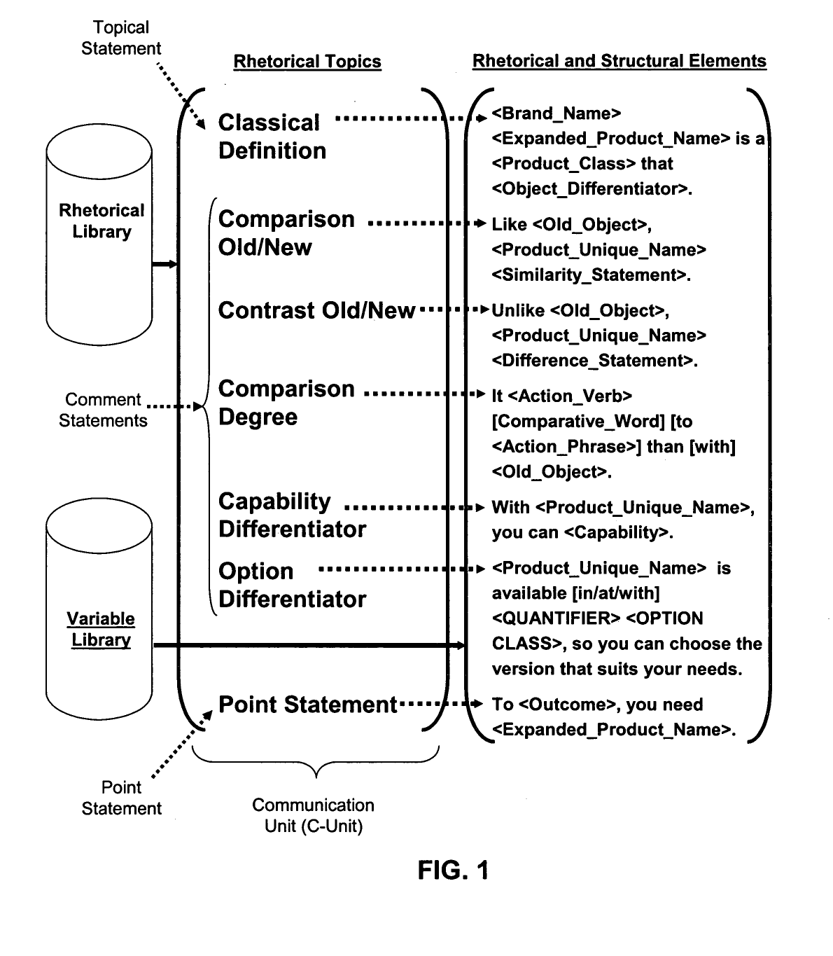

FIG. 1 depicts an exemplary embodiment of a rhetorical library with unpopulated variables of rhetorical topics. The rhetorical topics shown in FIG. 1 include a classical definition, a comparison between old and new, a contrast between old and new, a comparison as a matter of degree, a capability differentiator, an option differentiator, and a point statement. Each of these rhetorical topics can be subdivided into variable building blocks referred to as rhetorical and structural elements.

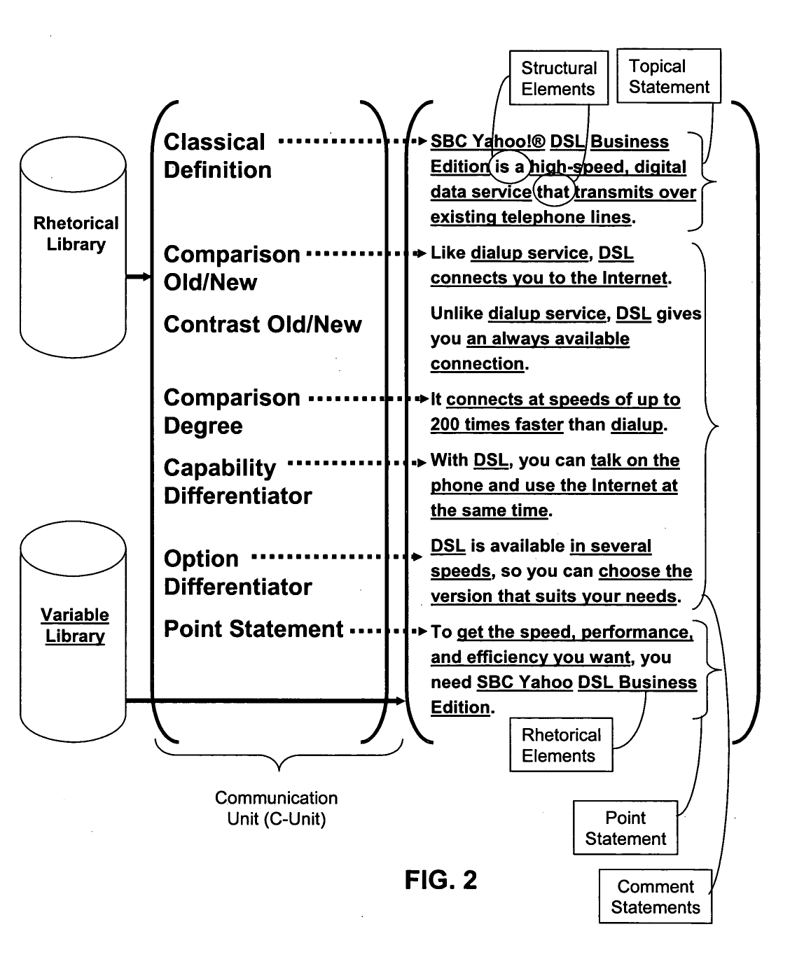

Rhetorical elements express ideas, while structural elements serve to combine ideas coherently to convey as clearly as possible a message to an audience. The rhetorical elements depicted with angle brackets are variables which can be dynamically populated to construct rhetorical topics of varying complexity and application. FIG. 2 illustrates how the rhetorical elements can be populated with rhetorical elements language to form repurposed rhetorical content. The rhetorical elements language consists of rhetorical content associated with the variables of each rhetorical topic. A variety of rhetorical elements language can be dynamically selected so as to repurpose content in a number of ways according to a chosen rhetorical purpose, knowledge of audience, and so on.

Structural elements referred to earlier conform to one or more rules for conveying a coherent expression. For example, written rhetoric as shown in FIGS. 1 and 2 utilizes structural elements governed by common rules of grammar associated with the language in question. Thus when rhetorical elements are combined with structural elements, a coherent expression can be formed such as shown in FIG. 2. It should be noted that although FIGS. 1 and 2 illustrate examples of English rhetoric, it would be apparent to one of ordinary skill in the art that any language is applicable to the present disclosure.

Once a set of rhetorical topics has been formed, a selection of the rhetorical topics such as shown in FIG. 2 can be used to form a communication unit (herein referred to as a “C-Unit”). A C-Unit is formed from a topic statement, one or more comment statements and a point statement. A simple C-Unit can roughly be equivalent to a paragraph. A complex C-Unit can be a combination of simple C-Units to create a larger functional entity within a document.

The topic statement (as is commonly referred to by writers of English) can be formed from a single rhetorical topic (such as the classical definition given in FIG. 2). The topic statement serves to convey to an audience a topic or theme. The comment statement(s) can be formed by one or more rhetorical topics. In the example of FIG. 2, the comment statements comprise the rhetorical topics of a comparison between old and new, a contrast between old and new, a comparison of degree, a capability differentiator, and an option differentiator. Comment statement(s) such as these can provide new information relating to the topic statement such as statements of fact or opinions. The point statement can be similarly formed by a rhetorical topic as shown in FIG. 2. The point statement can serve to convey an objective or purpose to be reached or achieved from a major idea or essential part of a concept or narrative.

A single C-Unit can represent any subset of languages such as a sentence, a paragraph, or a section of paragraphs. A C-Unit can serve to convey a simple message such as commonly found in advertisement clips. A combination of C-Units or complex C-Units, on the other hand, can form a schematic expression which can represent, for example, a complex document consisting of a multiplicity of sections (e.g., a marketing document, a legal agreement, a brochure, a product description, and so on). A C-Unit can be tailored to its audience on the basis of the variable library of rhetorical topics being populated with corresponding rhetorical content.

It should be noted that although FIGS. 1-2 depict written rhetoric, the present disclosure can be applied to audible rhetoric, tactile rhetoric, olfactory rhetoric, and other forms of visual rhetoric. Similar in principle to the rules of grammar, rules can be established for audible rhetoric, tactile rhetoric, olfactory rhetoric, and visual rhetoric. These rules can serve to combine audible or visual rhetorical elements with corresponding structured elements to convey coherent thoughts and/or messages to any number of audiences. Similarly, olfactory rhetoric which can consist of rhetoric affecting an end user's sense of smell that can be combined with other forms of rhetoric such as visual rhetoric (e.g., moving pictures). For example, the CMS 400 can be programmed to repurpose visual and olfactory rhetoric so as to produce visual and olfactory stimuli that cause a desired response of a targeted recipient end user.

Audible rhetoric can be represented by, for example, synthesized audible rhetoric or human audible rhetoric. Synthesized audible rhetoric can be generated by common software technologies that synthesize speech to text or text to speech. Human audible rhetoric derives from spoken language by either gender expressed in any context (e.g., formal presentations, drama, musical expressions, oratory, narrative, etc.). Tactile rhetoric can be represented by Braille which itself can be translated to written rhetoric and vice-versa. Visual rhetoric, of which written rhetoric is a subset, can also represent still image rhetoric (e.g., a cover page, a poster, a picture, a drawing, a sketch, a cartoon, etc.) of animate or inanimate objects, and moving image rhetoric (e.g., 2-D animation, 3-D animation, a video clip, Flash video, etc.). Audible or visual rhetoric can be structured as rhetorical topics constructed from the building blocks of audible or visual rhetorical and structural elements. Any of the foregoing types of rhetoric can be repurposed singly or in combination by the CMS 400 as will be described shortly.

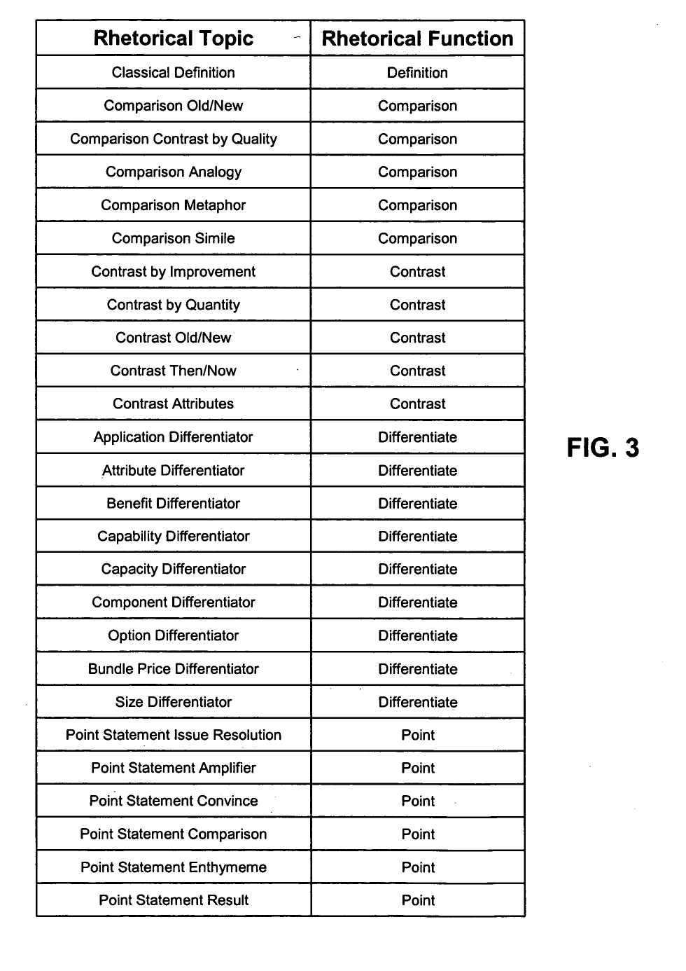

FIGS. 1-2 provide a small sample of C-Unit structures based on rhetorical topics and their building blocks. It would be apparent to an artisan with ordinary skill in the art that innumerable rhetorical topics can be identified from an expansive spectrum of contextual matters. Moreover, rhetorical topics themselves can be refined and subdivided in order to expand the scope of C-Units that can be generated from a rhetorical topic variable library. With this flexibility, C-Units can be tailored to a type of audience (e.g., novice, experienced, expert, young, middle aged, old, male, female, etc.). The table in FIG. 3 illustrates how the rhetorical topics of FIGS. 1 and 2 can be further refined. As should be evident from this table, rhetorical topics can be refined as much as may be deemed necessary. Although not shown, for each rhetorical topic of FIG. 3 a framework of variable rhetorical and structural elements can be formed similar to what is shown in FIG. 1. For convenience, the rhetorical topic variable library (a sample of which is shown in FIG. 1) will be referred to herein as a rhetorical topic library.

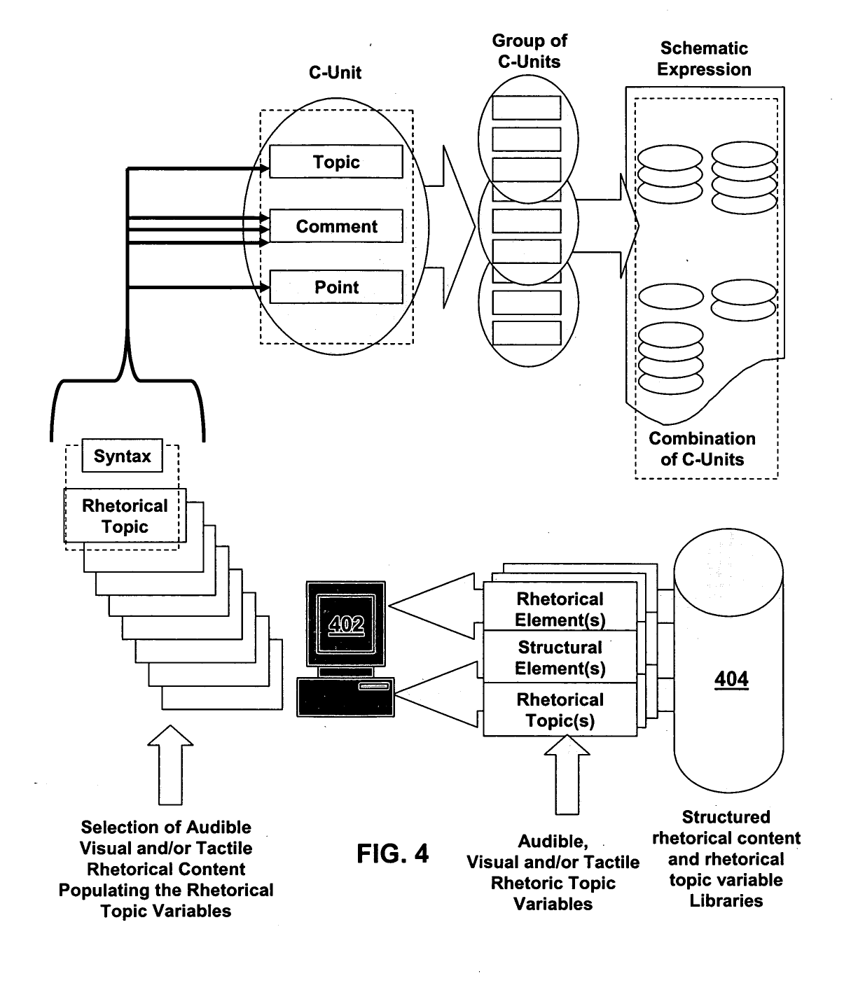

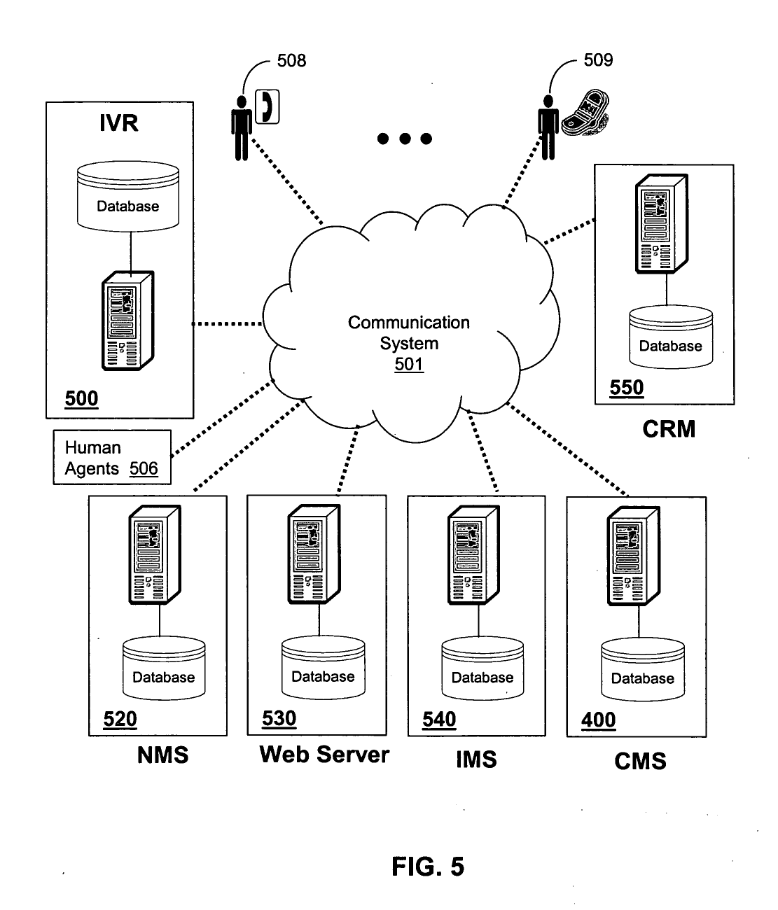

FIG. 4 depicts an exemplary embodiment of a content management system (CMS) 400 for constructing and repurposing rhetorical content. The CMS 400 comprises a controller 402 and a database 404. The controller 402 can comprise a computing device such as a server for managing operations of the database 404 as disclosed herein. The database 404 can comprise mass storage media such as one or more high capacity disk drives for storing any of the rhetorical content types (e.g., audible, visual or tactile rhetoric) described above. FIG. 5 depicts an exemplary embodiment of the CMS 400 operating in a communication system 603.

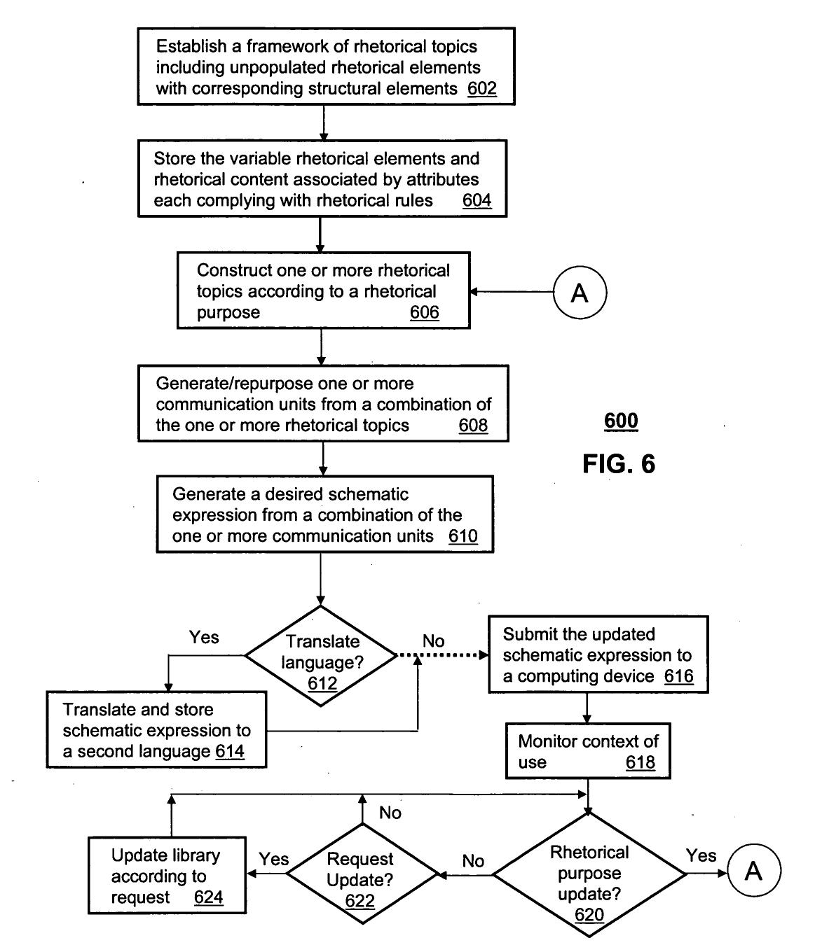

To facilitate an understanding of the embodiments of FIGS. 4-5, the reader's attention is directed to FIG. 6 which depicts an exemplary methods 600 operating in the CMS 400. Method 600 begins with step 602 where the controller 402 establishes a framework of rhetorical topics having variable rhetorical elements and corresponding structural elements much like FIG. 1. Each of the rhetorical topics can address specific subject matter areas (e.g., technical brochures, marketing collateral materials, customer tutorials, call processing trees for an interactive voice response system (IVR), call center operating procedures for its agents, web development, Internet search, Internet advertising creation, etc.). In a first embodiment, the framework of rhetorical topics can be established by subject matter experts who define a number of rhetorical topics according to rhetorical rules that facilitate the construction of C-Units as described earlier in FIGS. 1-4. Alternatively, the controller 402 can be programmed with software that utilizes common statistical techniques to identify patterns in pre-existing rhetorical topics to generate new rhetorical topics in an associated subject matter area.

In step 604 the same subject matter experts or other personnel of an enterprise can store in the database 404 the variable rhetorical elements (as a rhetorical library) and rhetorical content associated by functional attributes (such as pointers) to the variables in the rhetorical library. The stored variables and associated rhetorical content comply with rhetorical rules. The storage of the rhetorical variable elements can take place in a manner similar to the illustration of FIG. 1. Steps 602-604 can be accomplished by way of a GUI (Graphical User Interface) presented to end users of the CMS 400. It should be emphasized as noted above that the rhetorical topics created in steps 602-604 can represent singly or in combination visual rhetoric, audible rhetoric, and controllable olfactory rhetoric.

Once a framework of rhetorical topics has been established in the database 404, the controller 402 can be programmed to repurpose rhetorical content as depicted in steps 608-620. In step 608, the controller 402 can be programmed to construct according to a rhetorical purpose one or more rhetorical topics from the rhetorical library and rhetorical content associated with the rhetorical library according to its functional attributes. The rhetorical purpose can be supplied by an administrator of the CMS 400 to reflect a requested product. For example, the rhetorical purpose might be a software licensing agreement. Based on an expansive library of rhetorical topics stored in the database 404 relating to this rhetorical purpose (as well as others) the controller 402 can be directed in step 606 to generate one or more C-Units based on a combination of the of rhetorical topics constructed in step 606. One C-Unit can represent, for example, the agreement preamble of the software license agreement, another C-Unit can represent a definition section, another can represent grant clauses, another can represent confidentiality clauses, and so on. In step 608, the controller 402 can combine the C-Units into a schematic expression which in this illustration represents the license agreement in question. FIG. 4 depicts diagrammatically the aforementioned process from the construction of rhetorical topics to the generation of the schematic expression.

In a supplemental embodiment, the controller 402 can also be programmed with conventional language translation software to translate and store in step 612 a first language (e.g., English) of the schematic expression to a second language (e.g., French). Once translated, the schematic expression can be submitted in step 616 by the controller 402 to a computing device for further processing. The computing device can be an IVR 500, a web server or application 530 for directing content in a website, or a multimedia processing device such as cell phone 509—see FIG. 5. The schematic expression can thus represent a call processing tree for the IVR 500 for managing calls with end users 508, 509. Alternatively, the schematic expression can represent one or more web pages with one or more hyperlinks managed by the web server 530. In yet another embodiment, the schematic expression can be processed by a software application operating in the cell phone 509. The software application combined with the schematic expression can, for example, offer games to the end user, and/or promotions or rebates.

The controller 402 can also be programmed to generate or repurpose rhetorical content according to a context of use of the computing device monitored in step 618 against operating metrics. An operating metric can include for example:
demographic information, psychographic information, and/or sociographic information retrieved from a CRM (Customer Relationship Management) 550 for targeting specific end users 508, 509 with promotions and advertisement
commonly used financial metric ratios (e.g.,
an operating margin objective for the computing device (e.g., 40% margin in sales or better)
an operating expense objective for the computing device (e.g., less than 60% in operating costs)
one or more business models applied to product sales generated by the computing device
one or more business rules for customizing sales for customers on the basis of known information derived from the CRM 550 (e.g., a high valued customer, customer with low credit rating, etc.)
one or more customer satisfaction rules (e.g., redirecting a customer to a human agent 506 after reaching a timed threshold)
observed customer behavior (e.g., product preferences, time spent in certain areas of an IVR call processing tree, technical expertise of the customer, etc.)
observed customer feedback such as surveys provided during a product sale (e.g., selectable options given to a customer on what s/he liked and did not like about the sales process)
observed administrative personnel feedback such as the behavior and productivity of call center agents 506.

These and other possible operating metrics can be compared to the context of use of customers interacting with the computing device as monitored in step 618 to determine if the rhetorical purpose for which the schematic expression was generated in step 610 needs to be updated. For example, the controller 402 can detect in step 620 based on customer behavior that a change in the schematic expression of a call processing tree as it relates to product sales might improve sell-through of a particular product. In such a case, the controller 402 can be programmed to update the rhetorical purpose according to these observations, and proceed to steps 606-616 to repurpose the schematic expression in whole or in part according to the updated rhetorical purpose. Thus if an instance of repurposed content leads to an acceptance rate for a commercial offer, the controller 402 can continue to repurpose content according to any of the above metrics to continuously improve the acceptance rate. Consequently, the foregoing steps of method 600 provide a means to learn and repurpose content in a manner that optimizes one or more desirable metrics established by the administrator of the CMS 400 in order to ultimately draw a specific customer response.

If, on the other hand, the controller 402 does not detect in step 620 the need to update the rhetorical purpose, it can proceed to step 622 where it checks whether a request has been made to update the rhetorical library and/or associated rhetorical content for any of a number of languages stored in its database 404. If, for example, one or more rhetorical elements have been updated in a specific language (e.g., English) by an administrator or otherwise, the controller 402 can be programmed in step 624 to update all other associated rhetorical elements in other languages. The update may include, for example, invoking step 614 for translating the updated rhetorical topics into the other associated languages (e.g., French, German, Polish, etc.), and/or request assistance from administrators of the CMS 400.

Once the variable and associated rhetorical content libraries have been updated, the controller 402 continues to monitor the computing devices for a need to update in the rhetorical purpose. Alternatively, the controller 402 can be programmed to receive updates to the rhetorical purpose from a network management system (NMS) 520, or IP multimedia subsystem (540) each of which can manage the IVR 500 and/or the web server 530, and network elements in a hybrid communication system 501 supporting wireless (e.g., cellular, WiFi, WiMax, IPTV, Bluetooth, Ultra Wideband (UWB), Software Defined Radio (SDR), etc.) and wireline services (e.g., Public Switched Telephone Network).

The applications possible for constructing and repurposing rhetorical content as described above are endless. For example, method 600 can also be applied to managing an FAQ (Frequently Asked Questions) library operating in the web server 530. Method 600 can also be applied to assist human agents 506 serving as technical support service centers for customers. Moreover, method 600 can be applied in these embodiments and others to dynamically and proactively repurpose content as described above to adapt to a change in circumstances. It should also be noted that the present disclosure differs from prior art systems that create content on a ready-made basis. The present disclosure teaches a means for constructing and repurposing content on demand. Consequently, the present disclosure is much more flexible and adaptable to commercial needs as they may arise. Considering the expansive embodiments possible, the reader is directed to the claims described below for a full understanding of the scope and spirit of the present disclosure.

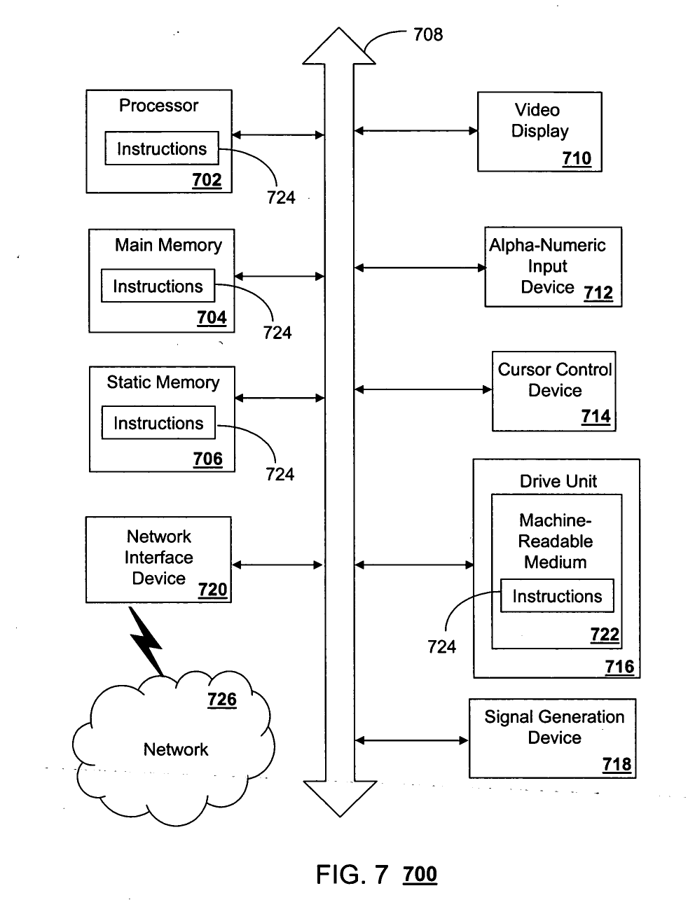

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 102 during execution thereof by the computer system 700. The main memory 704 and the processor 702 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a content management system, comprising computer instructions for:
receiving a rhetorical purpose for generating a desired schematic expression;
according to the rhetorical purpose,
constructing one or more rhetorical topics from a rhetorical library and rhetorical content associated with the rhetorical library according to one or more functional attributes;
generating one or more communication units from a combination of the one or more rhetorical topics; and
generating the desired schematic expression from a combination of the one or more communication units.

2. The storage medium of claim 1, comprising computer instructions for establishing a framework of rhetorical topics, each rhetorical topic including one or more variable rhetorical elements and corresponding structural elements conforming to rhetorical rules.

3. The storage medium of claim 2, comprising computer instructions for:
identifying the one or more variable rhetorical elements from the associated rhetorical content complying with the rhetorical rules; and
storing the updated framework of rhetorical topics.

4. The storage medium of claim 1, wherein the rhetorical library comprises at least one among visual rhetoric, audible rhetoric, tactile rhetoric, and olfactory rhetoric.

5. The storage medium of claim 4, wherein visual rhetoric comprises at least one among still image rhetoric, moving image rhetoric, and written rhetoric, wherein the audible rhetoric comprises at least one among synthesized audible rhetoric, and human audible rhetoric, and wherein tactile rhetoric comprises rhetoric in Braille.

6. The storage medium of claim 1, wherein each of the one or more rhetorical topics comprises one or more rhetorical and structural elements, and wherein each of the one or more structural elements conform to one or more rules for conveying a coherent expression.

7. The storage medium of claim 6, wherein the one or more rules comprise at least one among rules for audible rhetoric, rules for visual rhetoric, rules for tactile rhetoric, and rules for olfactory rhetoric.

8. The storage medium of claim 1, comprising computer instructions for:
updating the rhetorical purpose; and
updating a portion of the one or more communication units according to the updated rhetorical purpose.

9. The storage medium of claim 8, comprising computer instructions for:
constructing a new combination of one or more rhetorical topics from the rhetorical library and the rhetorical content associated by corresponding functional attributes; and
repurposing the portion of the one or more communication units according to the new combination of one or more rhetorical topics.

10. The storage medium of claim 8, comprising computer instructions for receiving the updated rhetorical purpose from at least one among a network management system (NMS), an interactive voice response system (IVR), a web server, an IP multimedia subsystem (IMS), and a multimedia processing device.

11. The storage medium of claim 1, comprising computer instructions for processing the desired schematic expression in at least one among an IVR, and a website.

12. The storage medium of claim 1, wherein the schematic expression is in a first language, and wherein the storage medium comprises computer instructions for translating a portion of the schematic expression to a second language.

13. The storage medium of claim 1, wherein each of the one or more communication units comprises a topic statement, one or more comment statements, and a point statement constructed from the one or more rhetorical topics.

14. The storage medium of claim 1, wherein the schematic expression comprises at least one among a proposal, an electronic brochure, a product description, and frequently asked questions.

15. The storage medium of claim 1, wherein the schematic expression comprises an advertisement having at least one among audible and visual rhetoric.

16. A content management system (CMS), comprising:
a controller for managing a database, programmed to:
construct one or more rhetorical and structural elements from a rhetorical library and rhetorical content associated with the rhetorical library by functional attributes; and
generate a schematic expression from a combination of the one or more rhetorical and structural elements.

17. The CMS of claim 16, wherein the rhetorical library comprises at least one among visual rhetoric, audible rhetoric, tactile rhetoric, and olfactory rhetoric, and wherein visual rhetoric comprises at least one among still image rhetoric, moving image rhetoric, and written rhetoric, wherein the audible rhetoric comprises at least one among synthesized audible rhetoric, and human audible rhetoric, wherein tactile rhetoric comprises rhetoric in Braille, and wherein olfactory rhetoric comprises rhetoric affecting a sense of smell.

18. The CMS of claim 16, wherein each of the one or more structural elements conform to one or more rules for conveying a coherent expression, and wherein the one or more rules comprise at least one among rules for audible rhetoric, and rules for visual rhetoric.

19. The CMS of claim 16, wherein the controller is programmed to:
receive a request to update a portion of the schematic expression according to a rhetorical purpose;
according to the rhetorical purpose,
construct a new combination of one or more rhetorical and structural elements from the rhetorical library and the rhetorical content associated by the functional attributes;
repurpose the portion of the schematic expression according to the new combination of one or more rhetorical and structural elements; and
generate an updated schematic expression according to the repurposed portion.

20. The CMS of claim 16, wherein the controller is programmed to:
monitor a context of use of the schematic expression operated on by a computing device;
detect a need to update to the schematic expression according to the monitored context of use;
repurpose a portion of the schematic expression according to the detected need; and
generate an updated schematic expression according to the repurposed portion.

21. The CMS of claim 20, wherein the controller is programmed to:
receive one or more operating metrics;
compare the one or more operating metrics to the monitored context of use; and
detect the need to update the schematic expression according to said comparison.

22. The CMS of claim 21, wherein the one or more operating metrics include at least one among a group of metrics comprising demographic information, psychographic information, sociographic information, an operating margin objective, an operating expense objective, financial metric ratios, one or more business models, one or more business rules, one or more customer satisfaction rules, observed customer behavior, observed customer feedback, and observed administrative personnel feedback.

23. A content management system (CMS), comprising:
a controller for managing a database, programmed to:
construct in a first language one or more rhetorical and structural elements from a rhetorical library and rhetorical content associated with the rhetorical library by functional attributes;
translate the one or more rhetorical elements in the first language to one or more rhetorical elements in a second language; and
store the one or more rhetorical elements as rhetorical content in the second language with functional attributes that associate to a corresponding rhetorical library in the second language.

24. The CMS of claim 23, wherein the controller is programmed to:
construct according to a rhetorical purpose a new combination of one or more rhetorical and structural elements in the second language from the rhetorical content and rhetorical library in the second language;
generate one or more communication units from the new combination of one or more rhetorical and structural elements in the second language;
generate a schematic expression from a combination of the one or more communication units.

25. The CMS of claim 23, wherein the controller is programmed to:
receive a request to update a portion of the one or more rhetorical and structural elements in the second language;
retrieve the portion of the one or more rhetorical and structural elements in the second language;
update according to the request the portion of the one or more rhetorical and structural elements in the second language; and
update according to the updated portion of the one or more rhetorical and structural elements in the second language a portion of the one or more rhetorical and structural elements in the first language associated therewith.

26. A computing device, comprising:
a controller programmed to:
receive a schematic expression from a content management system (CMS), wherein the schematic expression is generated by the CMS according to one or more communication units each having at least one or more rhetorical and structural elements;
present portions of the schematic expression to one or more end users according to operating rules of the computing device;
submit operating information to the CMS according to one or more operating metrics monitored by the CMS; and
receive an updated portion of the schematic expression from the CMS in response to the operating information submitted to the CMS.

27. The computing device of claim 26, wherein the computing device comprises one among an IVR, and a web application.

28. The computing device of claim 27, wherein schematic expression comprises one among a call processing tree of an IVR, and one or more web pages of a web application.
